(19) United States
(12) Patent Application Publication
(10) Pub. No.: US 2025/0339812 A1
(43) Pub. Date: Nov. 6, 2025

(54) ELECTROCHEMICAL DIRECT AIR CAPTURE OF CARBON DIOXIDE USING REVERSIBLE REDOX-ACTIVE MATERIAL

(71) Applicant: Massachusetts Institute of Technology, Cambridge, MA (US)

(72) Inventors: Hyowon SEO, Cambridge, MA (US); T. Alan HATTON, Sudbury, MA (US)

(21) Appl. No.: 18/867,172

(22) PCT Filed: Apr. 26, 2023
(86) PCT No.: PCT/US2023/019955

§ 371 Date: Nov. 19, 2024

Related U.S. Application Data
(60) Provisional application No. 63/355,701, filed on Jun. 27, 2022.

(51) Int. Cl. B01D 53/32; C25B 3/05; C25B 3/07; C25B 3/09; C25B 3/23; C25B 3/26; C25B 15/08

(52) U.S. Cl. CPC B01D 53/326; C25B 3/05; C25B 3/07; C25B 3/09; C25B 3/23; C25B 3/26; C25B 15/083; B01D 2257/504; B01D 2258/06

(57) ABSTRACT

An electrochemical direct air capture of carbon dioxide using a reversible redox-active material in an aqueous solution enabled by the inclusion of a hydrotropic agent. The electrochemical system demonstrates a high electron utility in continuous flow cell.

### CROSS-REFERENCE TO RELATED APPLICATIONS

This application claims priority to, and is a non-provisional of, U.S. Patent Application 63/355,701 (filed Jun. 27, 2022), the entirety of which is incorporated herein by reference.

### STATEMENT OF FEDERALLY SPONSORED RESEARCH OR DEVELOPMENT

This invention was made with government support under DE-AC05-76RL01830 awarded by the U.S. Department of Energy. The government has certain rights in the invention.

### BACKGROUND OF THE INVENTION

Direct air capture of carbon dioxide is a viable option for the mitigation of carbon dioxide (CO₂) emissions and their impact on global climate change. Conventional carbon capture processes from the air require 500 to 800 kJ thermal per mole of carbon dioxide, which accounts for the majority of the total cost of capture.

Increased atmospheric carbon dioxide concentration owing to the burning of fossil fuels is considered as the major factor in recent climate change and global warming. The atmospheric carbon dioxide concentration has increased continuously from the preindustrial value of 280 ppm to 410 ppm in 2021 induced by human activities, which currently emit close to 40 billion tons of carbon dioxide annually. Carbon capture and storage (CCS) technologies have been recognized as one of the important strategies to slow down changes in global climate patterns by effectively lowering carbon dioxide discharges. Conventional carbon dioxide capture has addressed carbon dioxide emissions from large point sources, such as fossil-fuel power stations and chemical plants. Since a considerable portion of carbon dioxide emissions is derived from mobile sources (e.g., 29% from transportation), direct air capture (DAC), in which carbon dioxide is captured directly from ambient air, is considered to be an important and viable option for reducing atmospheric carbon dioxide levels. While there are advantages of DAC in its potential to address emissions from distributed sources, the development and application of DAC processes have been restricted by their high operation cost. Currently, the energy requirements of the leading direct air capture technologies using sodium hydroxide scrubbing/lime causticization systems are around 500 to 800 kJ thermal per mole of carbon dioxide. Recent analysis suggested targeting the energy requirement to be less than 400 kJ thermal per mole of carbon dioxide (equivalent to 120 kJ/mol of electrical energy with Carnot efficiency of 0.3) by carbon dioxide-neutral power sources to be viable in order to be carbon dioxide negative.

To overcome these limitations of high energy requirements encountered by the systems using thermal energy, electrochemical systems have been recognized as a feasible option by the scientific society due to their potentially lower energy consumption under milder conditions of room temperature and pressure as highlighted in recent review articles. Electrochemical systems based on pH swings, reversible redox-active capturing agents, and electrochemically mediated amine regeneration (EMAR) have all been studied. Most systems involving redox-active capturing agents are suffering from their oxygen sensitivity which hampers its larger scale application. Industry is therefore desirous of finding oxygen-insensitive redox-active compounds that can capture carbon dioxide under highly dilute conditions (e.g., ambient air).

The discussion above is merely provided for general background information and is not intended to be used as an aid in determining the scope of the claimed subject matter.

### SUMMARY

This disclosure provides electrochemical direct air capture of carbon dioxide using a reversible redox-active material (e.g. neutral red, NR) in an aqueous solution enabled by the inclusion of a hydrotropic agent (e.g. nicotinamide, NA). The electrochemical system demonstrates a high electron utility in continuous flow cell. In one embodiment, the electrochemical system is a continuous flow system.

In a first embodiment, a method for concentrating carbon dioxide is provided. The method comprising: passing a gas into an electrochemical cell, wherein the gas comprises carbon dioxide at a first concentration and the electrochemical cell comprises water, an electrolyte, a hydrotropic agent and a reversible redox-active material selected from a group consisting of a phenazine, a phenothiazine, a phenoxazine or a salt thereof; electrolyzing the electrochemical cell to produce carbon dioxide at a second concentration, wherein the second concentration is greater than the first concentration.

In a second embodiment, an electrochemical system is provided. The electrochemical system comprising an electrochemical cell comprising a cathodic chamber and an anodic chamber separated by an anion exchange membrane, the electrochemical cell further comprising water, an electrolyte, a hydrotropic agent and a reversible redox-active material selected from a group consisting of a phenazine, a phenothiazine, a phenoxazine and a salt thereof; a catholyte reservoir that contains reduced neutral red (NRH2), the catholyte reservoir fluidly connected to the cathodic chamber; an anolyte reservoir that contains neutral red (NR), the anolyte reservoir fluidly connected to the anodic chamber; a gas input for providing a gas to the electrochemical system; a water input for providing water to the electrochemical system; a carbon dioxide output for removing carbon dioxide from the electrochemical system; a first fluid pathway for fluidly providing reduced neutral red (NRH2) from the anodic chamber to the catholyte reservoir; and a second fluid pathway for fluidly providing neutral red (NR) from the cathodic chamber to the anolyte reservoir.

This brief description of the invention is intended only to provide a brief overview of subject matter disclosed herein according to one or more illustrative embodiments and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A is a scheme of the reversible electrochemical carbon dioxide capture and release using NR/NRH2 redox system in water for direct air capture. Potentials are versus Ag/AgCl.

FIG. 1B shows NR solubility enhancement in water by the inclusion of 1 M NA as a hydrotropic agent.

FIG. 1C shows a cyclic voltammograms of 5 mM of NR under nitrogen and carbon dioxide in water with 0.1 M lithium perchlorate (LiClO₄) as a supporting electrolyte, and those of 10 mM of NR under nitrogen and carbon dioxide in water with 1 M NA as a hydrotropic agent and 0.1 M LiCIO₄ as a supporting electrolyte. All CV curves were recorded at room temperature, with a glassy carbon working electrode, at a scan rate of 50 mV/s. Potentials were recorded versus Ag/AgCl as a reference electrode.

FIG. 1D depicts a continuous flow electrochemical cell with NR/NRH2 redox cycle for carbon dioxide capture and release experiments from the air.

FIG. 2A depicts cyclic voltammograms of 10 mM NR at pH 6, 7, 8.5, and 12 in 1 M NA and 0.1 M LiCIO₄ solutions under nitrogen with a glassy carbon working electrode, at a scan rate of 50 mV per s. Potentials were recorded versus Ag/AgCl as a reference electrode.

FIG. 2B depict cyclic voltammograms of NRH with scan rates of 10, 25, 50, 100, and 200 mV per s.

FIG. 2C shows an analysis of NR redox reaction of peak current (i_{pc}) versus the square root of scanning speed (v^{1/2}) for the first and second reduction peaks.

FIG. 2D shows 100 cyclic voltammograms of NR.

FIG. 3A depicts a schematic of the experimental setup for carbon dioxide release. The electrochemical H-cell containing NRH2 solution to be oxidized by a constant current at room temperature was connected to the gas flow meter and an FT-IR carbon dioxide sensor.

FIG. 3B is a graph showing a solution of 4 mL of 50 mM NRH2 was oxidized by a constant current of 50 mA. The amount of released carbon dioxide and electron utilization are shown versus electric charge.

FIG. 4A is a graph showing carbon dioxide absorption profiles at carbon dioxide inlet gas stream concentrations of 1%, 4%, and 15%. An aqueous 50 mM NRH2 solution was contacted with the gas at a flow rate of 3.3 mL per min at room temperature.

FIG. 4B is a graph showing normalized carbon dioxide absorption profiles.

FIG. 4C is a graph showing in situ pH measurement during carbon dioxide bubbling. Plots of pH versus time are displayed for 5 mL of 50 mM NRH2 solution with carbon dioxide inlet gas stream concentrations of 1%, 4%, and 15% at a flow rate of 100 mL per min.

FIG. 4D is a graph comparing the carbon dioxide absorption profile with 15% carbon dioxide for NRH2 (50 mM in 1 mL of water) to those for ethylenediamine (EDA, 50 mM in 1 mL of water) and monoethanolamine (MEA, 50 mM in 1 mL of water). A flow of 15% carbon dioxide concentration balanced by nitrogen was used at a flow rate of 3.3 mL permin.

FIG. 4E is a graph comparing the carbon dioxide absorption profiles with 4% carbon dioxide.

FIG. 4F is a graph comparing the carbon dioxide absorption profiles with 1% carbon dioxide.

FIG. 5A is a graph showing carbon dioxide released by electrochemical oxidation on the application of a constant current of 50 mA to the NRH2 solution (50 mM, 4 mL) bubbled with air for 3 h at a flow rate of ca. 120 mL per min.

FIG. 5B is a graph of an in situ pH measurement during air bubbling, showing pH versus time for 5 mL of 50 mM NRH2 solution with ambient air.

FIG. 5C is a UV-vis spectra for the oxygen sensitivity test. The NRH2 solutions (50 mM, 1 mL) were bubbled with pure dioxygen for 30 min, 2 hours, and 1 day at a flow rate of 3 mL per min and sealed under dioxygen for 1 week.

FIG. 5D is a UV-vis spectra for the control experiment under nitrogen. The NRH2 solutions (50 mM, 1 mL) were bubbled with nitrogen for 30 min, 2 hours, and 1 day at a flow rate of 3 mL per min and sealed under nitrogen for 1 week.

FIG. 5E is a UV-vis spectra for the stability test under carbon dioxide. The NRH2 solutions (50 mM, 1 mL) were bubbled with pure carbon dioxide for 30 min, 2 hours, and 1 day at a flow rate of 3 mL per min and sealed under carbon dioxide for 1 week.

FIG. 5F is a UV-vis spectra for the stability test under air. The NRH2 solutions (50 mM, 1 mL) were bubbled with air for 30 min, 2 hours, and 1 day at a flow rate of 5 mL per min and sealed under air for 1 week.

FIG. 6A depicts a continuous flow electrochemical cell using NRH/NRH2 redox cycle for carbon dioxide capture and release experiments.

FIG. 6B is a graph showing released carbon dioxide amount over time using 15% carbon dioxide.

FIG. 6C is a graph showing electron utilization over time using 15% carbon dioxide. Electrolytes comprised 15 mL of 50 mM NRH2 in 1 M NA and 1 M KCl and 15 mL of 50 mM NRH in 1 M NA and 1 M KCl in water. The curve indicates the average value of electron utilization for each cycle. The inset numbers indicate the cycle number.

FIG. 6D is a graph showing released carbon dioxide amount over time using ambient air.

FIG. 6E is a graph showing electron utilization over time using ambient air. Electrolytes comprised 20 mL of 50 mM NRH2 in 1 M NA and 1 M KCl and 20 mL of 50 mM NRH in 1 M NA and 1 M KCl in water. The curve indicates the average value of electron utilization for each one-way travel (circulation time/2). The inset numbers indicate the time/circulation time.

### DETAILED DESCRIPTION OF THE INVENTION

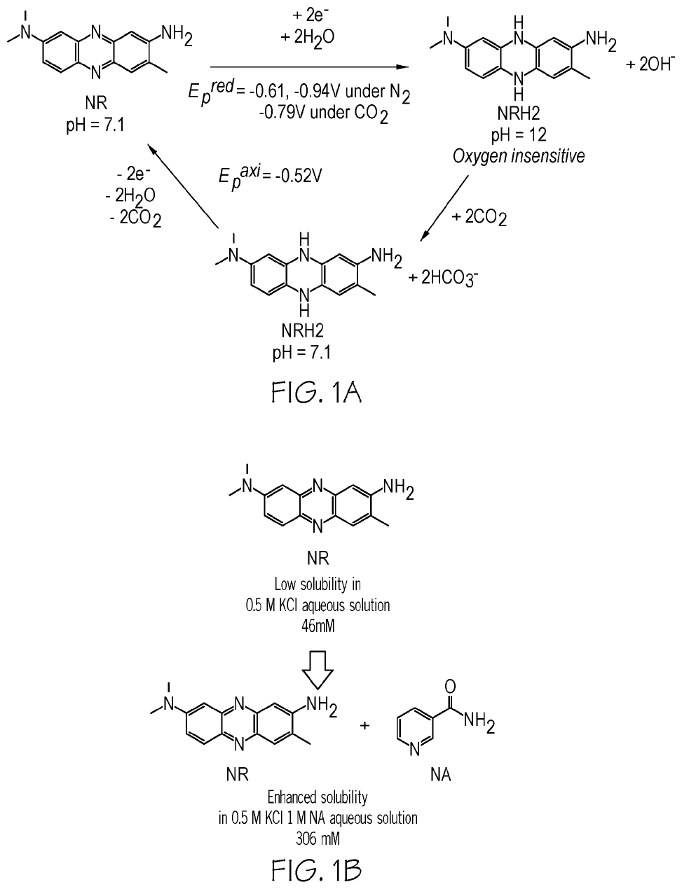

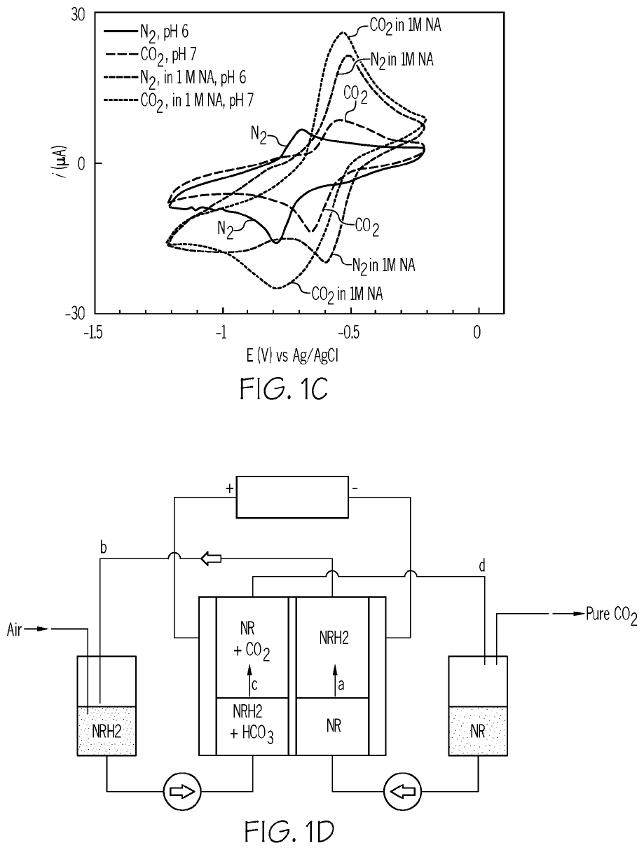

Phenazines, phenothiazines and phenoxazines are electron-rich heterocyclic organic x-systems that often favorably fulfill the requirements of organic redox-active compounds due to their reversibility in an aqueous system. In this respect, there has been extensive research employing phenazine, phenothiazine and phenoxazine derivatives in redox-flow batteries and electrochemical carbon capture via proton coupled electron transfer (PCET) in an aqueous system. Although several efforts to engage those compounds in the electrochemical direct air capture with potentially low energy consumption have been reported, most systems suffered from oxygen sensitivity and required synthetic modification to overcome the low aqueous solubility. For these reasons, none of the phenazine-based, phenothiazine-based and phenoxazine-based systems were reported to demonstrate capture of carbon dioxide from ambient air. Direct air capture using a reversible electrochemical system with low energy consumption benefiting from the reversible PCET redox couples in an aqueous solution can be achieved by eliminating oxygen sensitivity of the redox-active compound and enhancing its aqueous solubility. This disclosure provides electrochemical direct air capture of carbon dioxide using neutral red (NR), a commercial organic dye molecule, as an oxygen insensitive organic redox-active compound (FIG. 1A) in the presence of nicotinamide (NA) as a hydrotropic agent to increase its solubility in the aqueous system (FIG. 1B). The minimum energy requirements are estimated to be 35 kJₑ per mol of carbon dioxide with a 15% carbon dioxide feed, and 64 kJₑ per mol for direct air capture.

An example of the disclosed method for electrochemical carbon capture using a redox system is illustrated in FIG. 1A. This example utilizes a NR/leuco-neutral red (NRH2) redox system. The redox-active compound may be present as its corresponding salt (e.g. the HCl salt). In the example depicted, NRH2, the reduced product from NR, was formed by electrochemical potential with basification of the aqueous solution to pH 12 (experimentally obtained). A water-soluble electrolyte, such as an alkali or alkaline earth metal salt of a halide, perchlorate, nitrate, phosphate, carbonate, sulfate or the like is present. The electrolyte is generally present in a concentration of at least 0.1M to about 4M.

Other suitable redox-active compounds include Toluidine Blue, Thionin, Safranin O, Azure B, Nile Blue, Phenosafranine, Azure A, Methylene Blue and Brilliant Cresyl Blue. While the detailed example provided in this specification uses NR as a working example, cyclic voltammetry (CV) under N₂ and CO₂ shows these redox-active compounds are also functional.

In one embodiment, the redox-active compound is a phenazine, or a salt thereof, having a structure of:

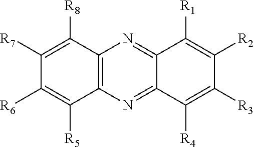

wherein R₁, R₂, R₃, R₄, R₅, R₆, R₇ and R₈ are independently selected from H, CH₃, NH₂, N(CH₃)₂, N(CH₂CH₃)₂ and NHCH₃.

In one embodiment, the redox-active compound is a phenothiazine, or a salt thereof, having a structure of:

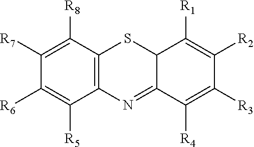

wherein R₁, R₂, R₃, R₄, R₅, R₆, R₇ and R₈ are independently selected from H, CH₃, NH₂, N(CH₃)₂, N(CH₂CH₃)₂ and NHCH₃.

In another embodiment, the redox-active compound is a phenoxazine, or a salt thereof, having a structure of:

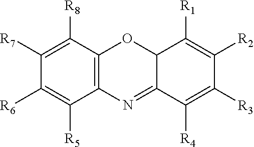

wherein R₁, R₂, R₃, R₄, R₅, R₆, R₇ and R₈ are independently selected from H, CH₃, NH₂, N(CH₃)₂, N(CH₂CH₃)₂ and NHCH₃.

After basification, a carbon dioxide rich gas stream was introduced to saturate and consequently acidify the solution. Subsequent electrochemical oxidation of the carbon dioxide saturated solution regenerated NR and released free carbon dioxide. The base form NR would mainly participate in the redox process due to the system operates at a pH range of 6-12. The amount of hydroxide ion formed by electrochemical reduction of the NR/NRH equilibrium (pKa=6.8) mixture can be estimated to be 1.2 to 1.67 equivalent depending on the pH values of the starting solutions.

Although the low aqueous solubilities of phenazines, phenothiazines and phenoxazines would be low in electrolyte solutions in most cases, the inclusion of 1 M of NA as a hydrotropic agent, increases the solubility of NR in 0.5 M potassium chloride aqueous solution from 46 mM to 306 mM. Other suitable hydrotropic agents include salts of a toluenesulfonate (e.g. a salt of p-toluenesulfonate, such as the sodium salt), ibuprofen salts, benzoate salts, salicylate and acetate salts. Further suitable hydrotropic agents include glycerol, urea and isonicotinamide.

Cyclic voltammetry (CV) curves recorded to compare the redox activity of NR/NRH2 in 1 M NA solution to those in the absence of NA under 1 atm N₂ and 1 atm carbon dioxide atmospheres are shown in FIG. 1C, where the first set of CV curves obtained in the absence of NA is displayed. Under the N₂ atmosphere, NR showed a cathodic peak at −0.79 V vs Ag/AgCl and an anodic peak at −0.68 V vs Ag/AgCl. When the electrolyte solution was saturated with carbon dioxide, the voltammogram showed a positively shifted single cathodic peak at −0.65 V and an anodic peak at −0.54. Then the second set of CV curves was recorded in the presence of NA (FIG. 1C). Under the N₂ atmosphere, two sets of cathodic and anodic peaks appeared at −0.60 V and −0.50 V and at −0.97 V and −0.82 V. These are attributed to the stepwise two single-electron transfers. When the carbon dioxide was introduced to the electrolyte solution with adjustment of the pH value to pH 7, two sets of cathodic and anodic peaks were merged to show a single cathodic peak at −0.79 V and two anodic peaks at −0.61 V and −0.52 V. The electrochemical carbon capture system in this disclosure was demonstrated using a 50 mM NR solution in the presence of 1 M NA as a hydrotropic agent. In other embodiments, the redox-active compound is present in a concentration between 0.1 mM and 1000 mM. In other embodiments, the hydrotropic agent is present in a concentration between 0.1M and 4M.

Elsewhere in this disclosure, a continuous flow electrochemical direct air capture with the NR/NRH2 redox system is disclosed in further detail (FIG. 1D). Briefly, NR was reduced electrochemically to provide NRH2 with an increase in the pH of the solution (path a). The basic aqueous solution was pumped to the reservoir where an air or a carbon dioxide-rich gas stream was introduced (path b). The carbon dioxide saturated solution was then pumped to the anodic chamber where electrochemical oxidation led to regeneration of NR and release of free carbon dioxide (path c). Then the resulting solution was transferred to the anolyte reservoir to discharge carbon dioxide and close the flow cycle (path d). The continuous operation of the flow cell was demonstrated with 15% carbon dioxide and ambient air.

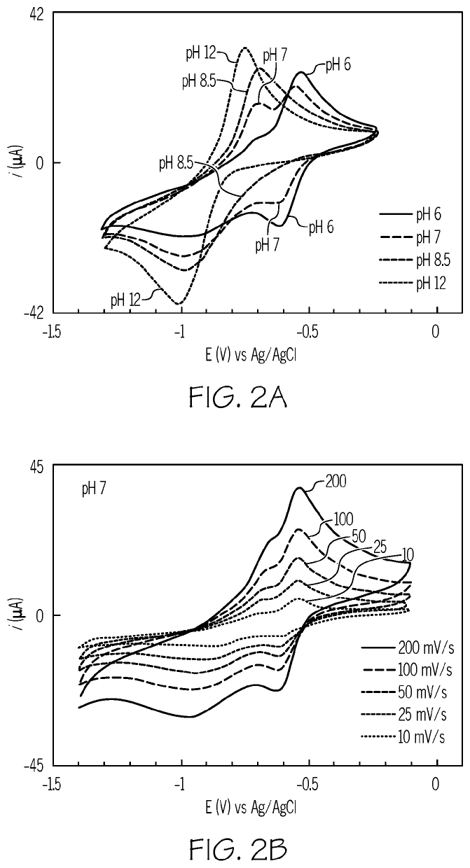

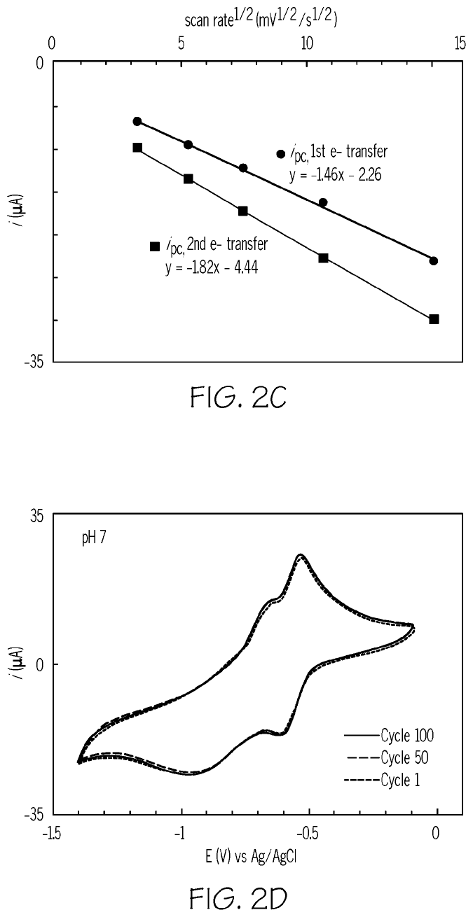

The electrochemistry of the NR aqueous solution was examined by CV at various pH levels between 6 and 12 (FIG. 2A). Two sets of peaks were observed, corresponding to the first and second single-electron transfers of NR via He e H mechanism. The first single-electron reduction peak appears at −0.61 V with the second reduction peak at −0.94 V and two single-oxidation peaks at −0.68 V and −0.52 V vs Ag/AgCl. As the solution pH increases, the first single-electron reduction peak decreases with merging to the second electron transfer peak, which is consistent with the He e H mechanism. As shown by the CV of NR at different scan rates in FIG. 2B, a difference in two slope values (FIG. 2C) between a linear relationship of the peak currents (i_{pc}) to the square root of the scan rates for the first and second single-electron reductions indicates that the first reduction is kinetically slower in pH 7, while the second reduction is not, which also supports the He e H mechanism at pH greater than pKa. Based on the experimental pH measurement at each step and results from the CV experiment in FIG. 1A and FIG. 2A, the minimum potential gap for the electrochemical swing process should be in the range of 0.42 V. The minimum potential gap in the cyclic system in which carbon dioxide is dissolved in the solution would be smaller to 0.26 V based on CV in FIG. 1C. The merge of the first and second reduction peaks in the presence of carbon dioxide suggests pre-association of carbon dioxide and NR that could facilitate electron transfers. The NR/NRH2 redox reaction demonstrates good reversibility and excellent redox durability, with no significant decay in the peak current after 100 cyclic voltammetry cycles (FIG. 2D).

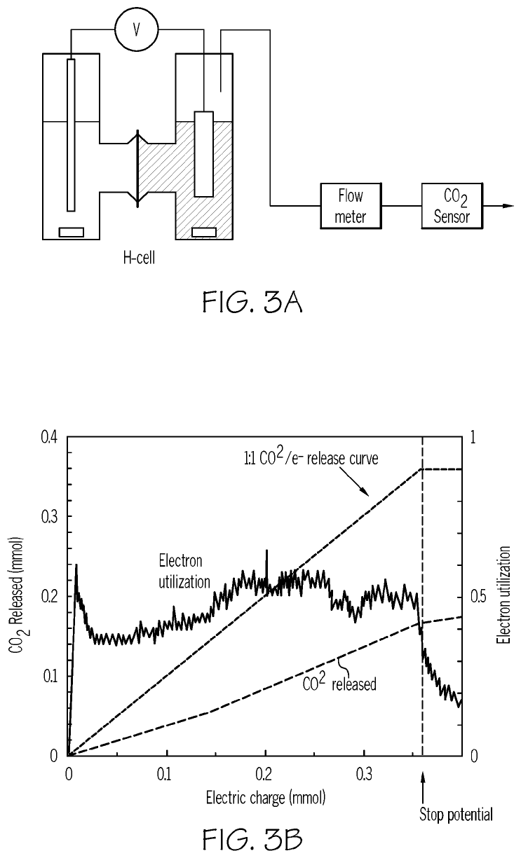

A bench-scale setup using an electrochemical H-cell was constructed for the carbon dioxide capture and release in the NR/NRH2 redox system (FIG. 3A). The system was equipped with an anion exchange membrane separating two 5 mL reaction chambers, carbon felt as a working electrode, and a stainless steel wire electrode for an arbitrary reaction in the counter chamber. The 4 mL reaction mixture containing 50 mM NR (200 mmol) in water in the presence of 1 M NA as a hydrotropic agent and 0.5 M LiCIO₄ as a supporting electrolyte was electrochemically reduced in a constant current mode at 50 mA for 695 s (equivalent to 360 mmol of electrons transferred) to yield 90% reduction of the NR to NRH2. Then a 15% carbon dioxide gas stream was introduced for 10 min to saturate the solution. The output gas flow from the carbon dioxide saturated solution upon anodic oxidation was quantified and qualified by a carbon dioxide flow meter and an FT-IR carbon dioxide sensor, respectively. Plots of the amount of carbon dioxide released by electrochemical oxidation versus electric charge are displayed in FIG. 3B. The electron utilization for the carbon dioxide release by oxidation represents the ratio between the moles of carbon dioxide released per moles of electrons transferred. Quantitative carbon dioxide release providing electron utilization of 0.50 was obtained, accounting for the delayed release of carbon dioxide from the cell. Combining the voltage difference (0.42 V) between the peak potentials from the CV measurements with the electrochemical electron utilization of 0.50 during carbon dioxide release, the minimum energy requirement is estimated to be 84 kJ per mol in batch.

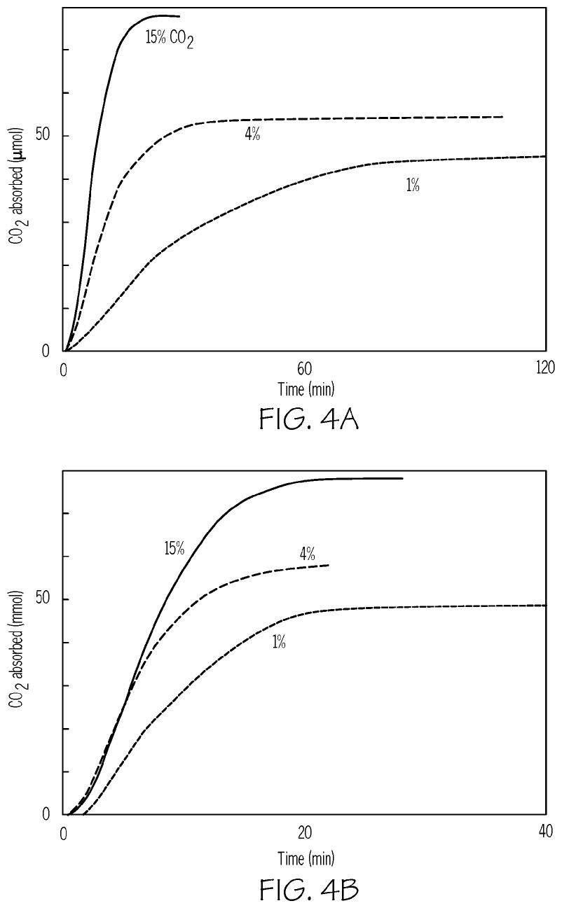

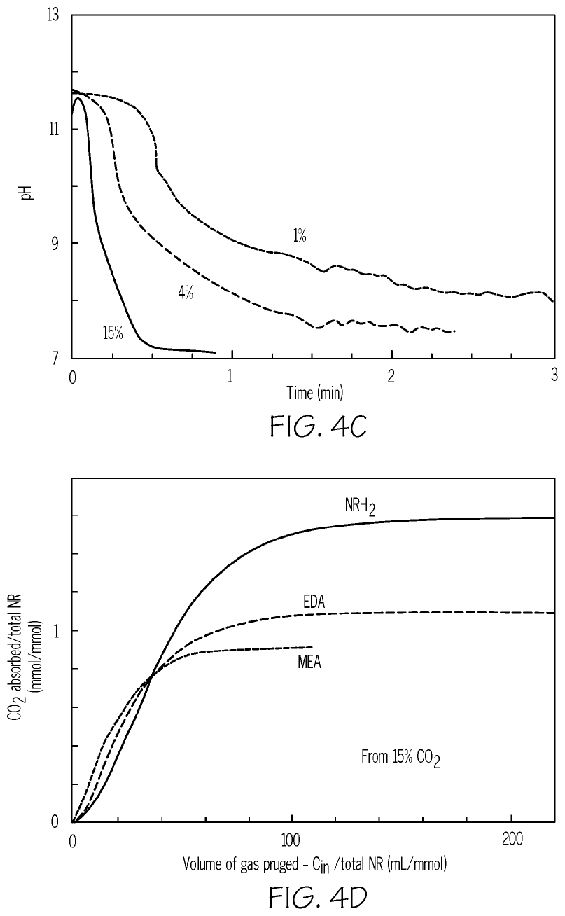

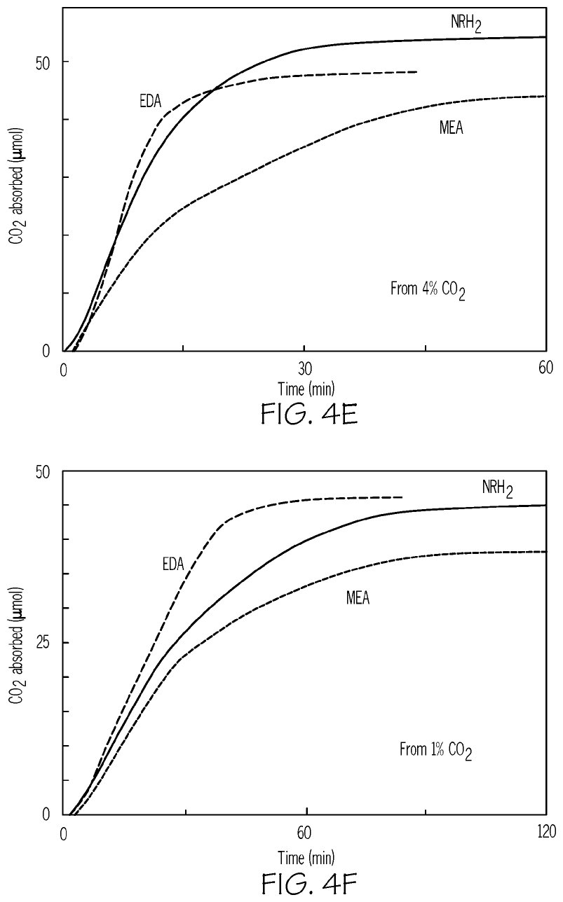

The carbon dioxide absorption dynamics were investigated using 1 mL of 50 mM NRH2 solutions as shown in FIGS. 4A to 4F. As depicted in FIG. 4A, the NR solution showed different profiles for the 1, 4, and 15% carbon dioxide feeds. Solution saturation by 15% carbon dioxide showed absorption of 78 μmol of carbon dioxide which corresponds to 1.56 equivalent to NRH2, consistent with the amount of hydroxide anion estimated (1.67 equivalent to NRH2, see supporting information). The carbon dioxide absorption was less efficient when using 4 and 1% carbon dioxide gas streams that provide the amount of carbon dioxide absorbed of 55 μmol (1.1 equivalents to NRH2) and 45 μmol (0.9 equivalents to NRH2), respectively. The curves superimpose in the initial absorption period when normalized by the inlet carbon dioxide concentration, shown in FIG. 4B, which indicates a consistent behavior of the solution regardless of the inlet concentration during the early stages of absorption. However, it shows less utilization of the capacity of the solution when using lower carbon dioxide concentrations of the inlet gas streams.

Absorption was also monitored by the in situ pH measurement of 5 mL of 50 mM NRH2 solution while blowing 1, 4, and 15% carbon dioxide stream at a flow rate of ca. 100 mL per min (FIG. 4C). The final pH value after saturation was 7.1 with 15% carbon dioxide, 7.4 with 4% carbon dioxide, and 8.1 with 1% carbon dioxide which are consistent with the results in FIG. 4A and FIG. 4B. Next, carbon dioxide absorption profiles were compared with conventional amines, ethylenediamine (EDA) and monoethanolamine (MEA) using 50 mM solutions each (FIG. 4D, FIG. 4E and FIG. 4F). The initial carbon dioxide absorption rate in the NRH2 solution was comparable to that in EDA and the amount of absorbed carbon dioxide was 56% higher than that with EDA when using a 15% carbon dioxide inlet gas stream (FIG. 4D). The absorption rate by the NRH2 solution with 4% carbon dioxide was also as fast as that by EDA. However, the NRH2 solution shows slower absorption than EDA with the 1% carbon dioxide gas feed. In all cases, carbon dioxide absorption by NRH2 solution was faster than by the MEA solution.

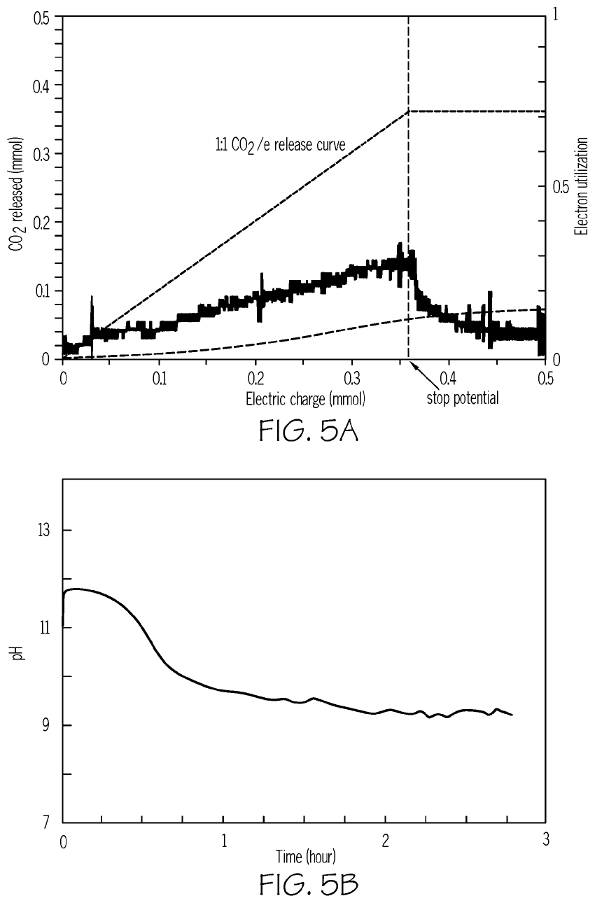

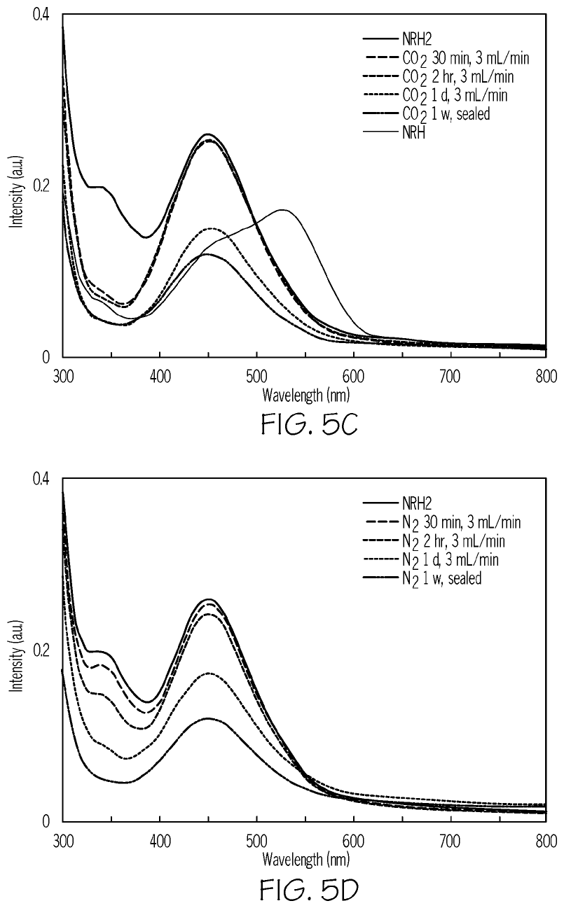

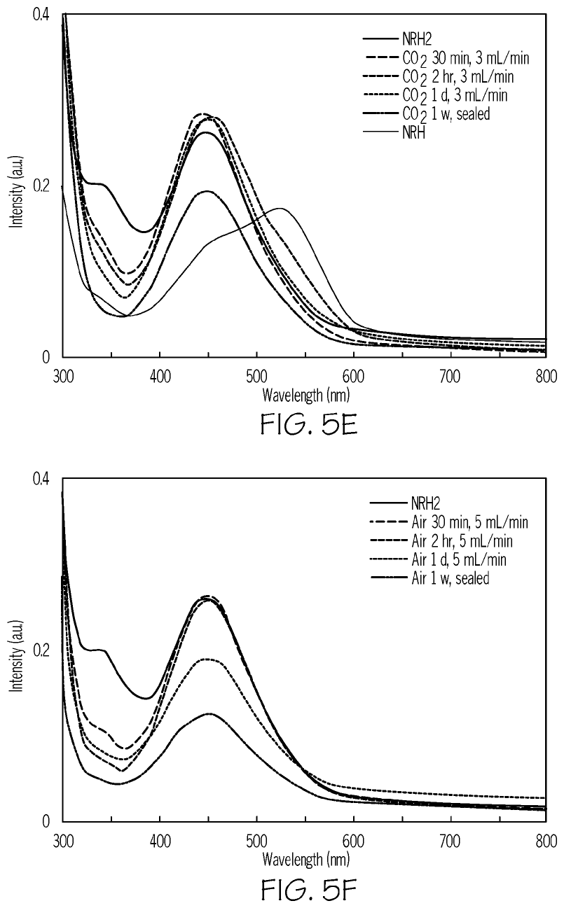

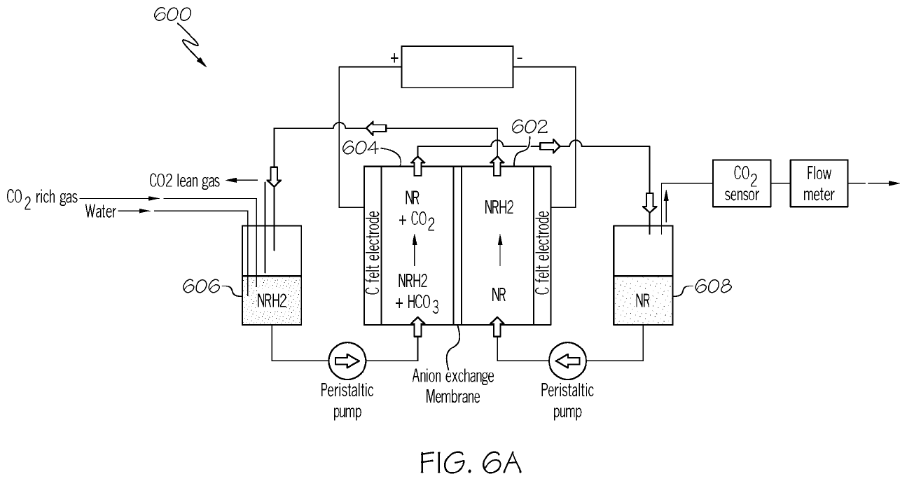

The potential for electrochemical direct air capture using the NR/NRH2 redox system was investigated (FIGS. 5A to 5F). The 45 mM NRH2 solution that was prepared by electrochemical reduction was contacted with non-pretreated air for 3 h at a flow rate of about 120 mL per min (FIG. 5A). Electrochemical oxidation of the air-contacted solution was carried out to evaluate the direct air capture efficiency. The system presented a relative electron utilization during carbon dioxide release of up to 0.33 and an average value of 0.21 of electron utilization under the current conditions. Considering the electron utilization (0.33) during carbon dioxide release and the potential difference obtained from the CV, direct air capture under the current conditions requires the estimated minimum work input to be 123 kJ per mol. Although further engineering optimizations are warranted, the estimated minimum energy ranges are promising to be in the range of 400 kJ per mol thermal (equivalent to 120 kJₑ per mol with a Carnot efficiency of 0.3), which is considered a target to be achieved by DAC technologies.⁵ The absorption of carbon dioxide during bubbling of air was monitored by in situ measurement of pH (FIG. 5B), which dropped from 12 to 9.1 in 3 h. The absorption rate from the ambient air was comparable to that of a 1% carbon dioxide concentration inlet based on the pH value measurements as depicted in the normalized plot (see supporting information).

The NRH2 solution was shown to be insensitive to oxygen as observed in a set of UV-vis absorption spectroscopy experiments under various conditions (FIG. 5C, FIG. 5D, FIG. 5E and FIG. 5F). The 50 mM NRH2 solutions prepared by electrochemical reduction in the presence of 1 M NA and 0.5 M potassium chloride (KCl) in water were bubbled with pure oxygen, nitrogen, carbon dioxide, and ambient air for 24 h. The freshly prepared NRH2 solution showed two absorption peaks in the range of 300-800 nm by UV-vis absorption spectroscopy. The larger peak at 455 nm is attributed to the NRH2 and the smaller peak at 345 nm is presumably from the radical species. In FIG. 5C, the peak intensity at 455 nm was maintained for 2 h with contacting pure oxygen. Longer studies for a day and a week provided peak intensities of NRH2 lowered by 42% and 52%, respectively, in the solution sealed under an oxygen atmosphere after 24 h of bubbling with oxygen. The peak at 345 nm disappeared rapidly over 30 min to regenerate NR. As a control experiment, nitrogen was introduced to the 50 mM NRH2 solution at a same flow rate (FIG. 5D). Initial degradation of the peak intensity at 455 nm and 345 nm was slower during the first 2 h. The peak intensity measured after 24 h and a week provided the peak intensity degradation by 33% and 53% respectively. These results suggest contacting oxygen did not contribute much to the degradation of UV-vis peak intensity of NRH2 at 455 nm, while the 345 nm peak was rapidly disappearing by reacting with oxygen. The factors contributing to the 455 nm peak degradation were examined, including decomposition, reoxidation, precipitation, and polymerization. By NMR studies of the NRH2 solutions, NRH2 precipitation due to its low solubility under the current condition led UV-vis peak degradation. Solubility can be improved by the inclusion of a higher concentration of NA or choice of supporting electrolyte. No major decomposition, reoxidation, or polymerization products of NRH2 were observed by NMR studies.

A third set of UV-vis absorption measurements (FIG. 5D), this time on solutions contacted with carbon dioxide, was carried out. Interestingly, no significant degradation of peak intensity at 455 nm was observed by UV-vis absorption spectroscopy after a day. These results indicated that the homogeneity of the NRH2 solution is better maintained under the carbon dioxide atmosphere possibly due to the neutral pH of the solution. The peak at 345 nm, however, disappeared rapidly in 30 min accompanied by bumps at about 490 nm and about 550 nm, which may be due to the regeneration of NR and NRH, respectively (see supporting information). Based on this result, at this point carbon dioxide reduction by the radical species formed by electrochemical reduction under the imposed current conditions cannot be ruled out. The final set of UV-vis absorption experiments in FIG. 5F was carried out using solutions bubbled with ambient air. Although the intensities of the 455 nm peak were the same for the samples after 30 min and 2 h contact, respectively, similar levels of degradation as observed with solutions contacted with oxygen were observed with longer samples storage times.

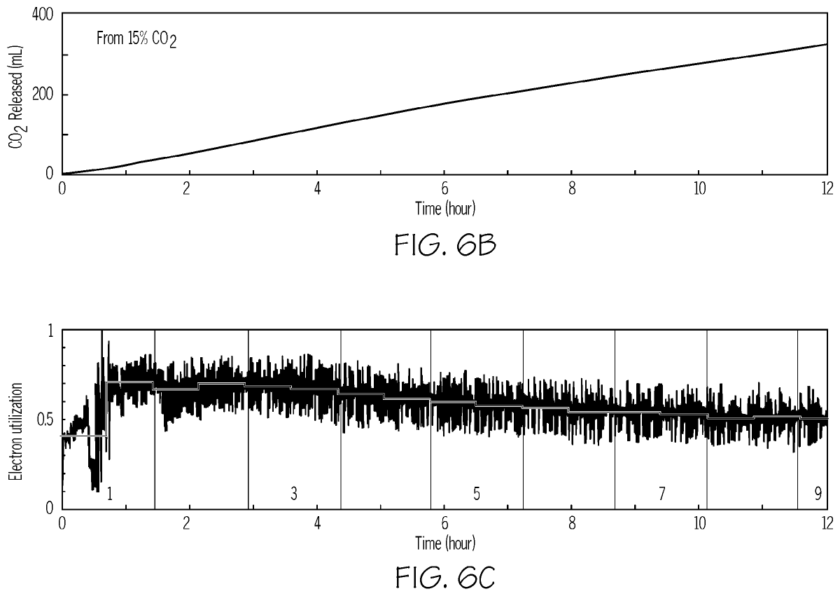

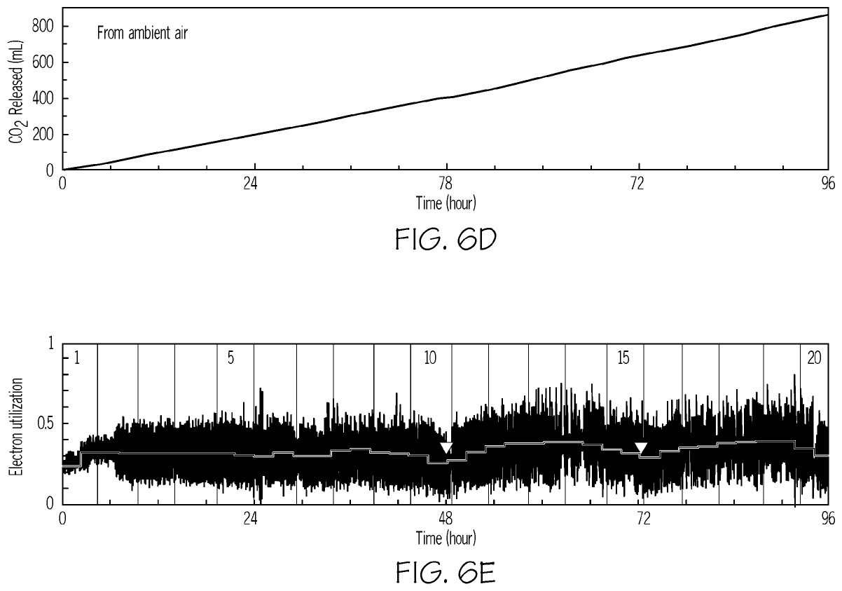

A continuous flow cell was constructed to process 50 mM NR solution in the presence of 1 M NA and 1 M potassium chloride KCl as a supporting electrolyte due to its better conductivity and higher solubility of neutral red in water to avoid clogging of the flow system. A schematic of a flow cell 600 is shown in FIG. 6A. The flow cell structure was designed with carbon felt electrodes on both chambers and an anion exchange membrane that divides the cell into a cathodic chamber 602 and an anodic chamber 604 and maintains the pH difference between them. The system is equipped with two reservoirs, one catholyte reservoir 606 that contains NRH2 which absorbs carbon dioxide from the carbon dioxide-rich gas stream, and an anolyte reservoir 608 that contains NR from which separated carbon dioxide would be discharged to be measured. The results of carbon capture from 15% carbon dioxide are displayed in FIG. 6B and FIG. 6C. 90% of the capacity of the system was utilized in order to minimize undesired side reactions under the constant current mode of operation at 50 mA with 15% carbon dioxide. The liquid flow rate was 0.349 mL per min, giving 6.3 min of residence time in the 2.2 mL volume of each chamber. The gas output and carbon dioxide fraction were recorded simultaneously during the operation to show reproducibility of carbon dioxide capture and release over a 12 h period, which corresponds to over 8 circulations of the solution through the system. The linearity of the cumulative carbon dioxide released over time depicted in FIG. 6B indicates steady state operation with a constant rate of carbon dioxide capture and release, yielding a separation of about 350 mL of carbon dioxide in 12 hours. In FIG. 6C, electron utilization, calculated from the carbon dioxide flow rate and the electric current, showed 0.41 for the first cycle and it jumped up to 0.71 from the second cycle with better stability. This electron utility over 0.5 can be explained by the estimated hydroxide ion equivalents based on the pH (see supporting information). The electron utilization dropped gradually to 0.5 after 12 hours. The minimum energy requirement can be estimated from the voltage gap obtained from CV experiments for the cyclic system (0.26 V) combined with the electron utility (0.71) to provide 35 kJ per mol of carbon dioxide.

To explore the possibility of using the NR/NRH2 flow cell for direct air capture, carbon dioxide capture and release was performed using ambient air as a feed gas (FIG. 6D and FIG. 6E). The scheme of the setup is the same as in FIG. 6A with a constant current mode of operation at 30 mA, a liquid flow rate of 0.218 mL per min (residence time of 10.1 min), and a flow rate of bubbling air of ca. 600 mL per min. In-house supply air was used without any pretreatment before the experiments. Additional water was injected at 1.5 mL per h to the catholyte to compensate for water evaporation by the rapid bubbling of the air through the solution. FIG. 6D presents the amount of released carbon dioxide over time. The system separated about 400 mL of carbon dioxide from ambient air over about 45 hours. As depicted in FIG. 6E the electron utilization was 0.26 for cycle 1 and gradually increased to 0.39 in 17 hours. The electron utilization was maintained at this level until 38 hours of operation, and then gradually decreased later. The minimum energy requirement for direct air capture can be estimated from the voltage gap obtained from CV experiments for the cyclic system (0.26 V) combined with the electron utility (0.39) to provide 64 kJ per mol of carbon dioxide.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for concentrating carbon dioxide, the method comprising:
passing a gas into an electrochemical cell, wherein the gas comprises carbon dioxide at a first concentration and the electrochemical cell comprises water, an electrolyte, a hydrotropic agent and a reversible redox-active material selected from a group consisting of a phenazine, a phenothiazine, a phenoxazine or a salt thereof;
electrolyzing the electrochemical cell to produce carbon dioxide at a second concentration, wherein the second concentration is greater than the first concentration.

2. The method as recited in claim 1, wherein the reversible redox-active material is selected from a group consisting of Neutral Red, Brilliant Cresyl Blue, Nile Blue A, Azure A, Azure B, Toluidine Blue, Thionin, Methylene blue, Phenosafranine and Safranin O.

3. The method as recited in claim 1, wherein the reversible redox-active material is Neutral Red.

4. The method as recited in claim 1, wherein the hydrotropic agent is selected from a group consisting of nicotinamide or a salt thereof, a salt of a p-toluenesulfonate, a salt of ibuprofen, a benzoate salt, salicylate salt, an acetate salt, a glycerol, a urea, an isonicotinamide, and combinations thereof.

5. The method as recited in claim 1, wherein the hydrotropic agent is nicotinamide (NA) or a salt thereof.

6. The method as recited in claim 1, wherein the reversible redox-active material is Neutral Red and the hydrotropic agent is nicotinamide (NA) or a salt thereof.

7. The method as recited in claim 1, wherein the electrolyte is KCl.

8. The method as recited in claim 1, wherein the reversible redox-active material is present in a concentration between 0.1 mM and 1000 mM.

9. The method as recited in claim 1, wherein the redox-active compound is a phenazine, or a salt thereof, having a structure of: 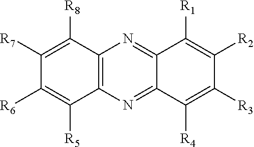
wherein R₁, R₂, R₃, R₄, R₅, R₆, R₇ and R₈ are independently selected from H, CH₃, NH₂, N(CH₃)₂, N(CH₂CH₃)₂ and NHCH₃.

10. The method as recited in claim 1, wherein the redox-active compound is a phenothiazine, or a salt thereof, having a structure of: 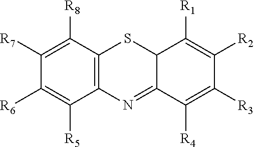
wherein R₁, R₂, R₃, R₄, R₅, R₆, R₇ and R₈ are independently selected from H, CH₃, NH₂, N(CH₃)₂, N(CH₂CH₃)₂ and NHCH₃.

11. The method as recited in claim 1, wherein the redox-active compound is a phenoxazine, or a salt thereof, having a structure of: 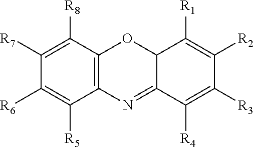
wherein R₁, R₂, R₃, R₄, R₅, R₆, R₇ and R₈ are independently selected from H, CH₃, NH₂, N(CH₃)₂, N(CH₂CH₃)₂ and NHCH₃.

12. An electrochemical system comprising:
an electrochemical cell comprising a cathodic chamber and an anodic chamber separated by an anion exchange membrane, the electrochemical cell further comprising water, an electrolyte, a hydrotropic agent and a reversible redox-active material selected from a group consisting of a phenazine, a phenothiazine, a phenoxazine and a salt thereof;
a catholyte reservoir that contains reduced neutral red (NRH2), the catholyte reservoir fluidly connected to the cathodic chamber;
an anolyte reservoir that contains neutral red (NR), the anolyte reservoir fluidly connected to the anodic chamber;
a gas input for providing a gas to the electrochemical system;
a water input for providing water to the electrochemical system;
a carbon dioxide output for removing carbon dioxide from the electrochemical system;
a first fluid pathway for fluidly providing reduced neutral red (NRH2) from the anodic chamber to the catholyte reservoir; and
a second fluid pathway for fluidly providing neutral red (NR) from the cathodic chamber to the anolyte reservoir.

13. The electrochemical system as recited in claim 12, wherein the reversible redox-active material is selected from a group consisting of Neutral Red, Brilliant Cresyl Blue, Nile Blue A, Azure A, Azure B, Toluidine Blue, Thionin, Methylene blue, Phenosafranine and Safranin O.

14. The electrochemical system as recited in claim 12, wherein the reversible redox-active material is Neutral Red.

15. The electrochemical system as recited in claim 12, wherein the hydrotropic agent is selected from a group consisting of nicotinamide or a salt thereof, a salt of a p-toluenesulfonate, a salt of ibuprofen, a benzoate salt, salicylate salt, an acetate salt, a glycerol, a urea, an isonicotinamide, and combinations thereof.

16. The electrochemical system as recited in claim 12, wherein the hydrotropic agent is nicotinamide (NA) or a salt thereof.

17. The electrochemical system as recited in claim 12, wherein the reversible redox-active material is Neutral Red and the hydrotropic agent is nicotinamide (NA) or a salt thereof.

18. The electrochemical system as recited in claim 12, wherein the redox-active compound is a phenazine, or a salt thereof, having a structure of: 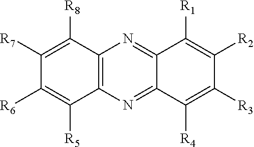
wherein R₁, R₂, R₃, R₄, R₅, R₆, R₇ and R₈ are independently selected from H, CH₃, NH₂, N(CH₃)₂, N(CH₂CH₃)₂ and NHCH₃.

19. The electrochemical system as recited in claim 12, wherein the redox-active compound is a phenothiazine, or a salt thereof, having a structure of: 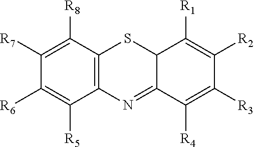
wherein R₁, R₂, R₃, R₄, R₅, R₆, R₇ and R₈ are independently selected from H, CH₃, NH₂, N(CH₃)₂, N(CH₂CH₃)₂ and NHCH₃.

20. The electrochemical system as recited in claim 12, wherein the redox-active compound is a phenoxazine, or a salt thereof, having a structure of: 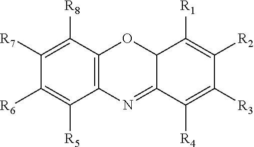
wherein R₁, R₂, R₃, R₄, R₅, R₆, R₇ and R₈ are independently selected from H, CH₃, NH₂, N(CH₃)₂, N(CH₂CH₃)₂ and NHCH₃.
